(19) United States
(12) Patent Application Publication
(10) Pub. No.: US 2022/0106973 A1
(43) Pub. Date: Apr. 7, 2022

(54) DEVICE FOR SECURING TURNBUCKLES

(71) Applicant: Paul Baehr, Sarasota, FL (US)

(72) Inventor: Paul Baehr, Sarasota, FL (US)

(21) Appl. No.: 17/065,467

(22) Filed: Oct. 7, 2020

(51) Int. Cl. F16B 7/06

(52) U.S. Cl. CPC F16B 7/06

(57) ABSTRACT

A device for locking a turnbuckle including a clip having an inner surface. A pair of arms extending from the inner surface, the arms are configured to capture a portion of the turnbuckle. A pin extending from the inner surface, wherein the pin is configured for insertion into the stud of the turnbuckle to resist rotation. Systems and methods are disclosed.

### TECHNICAL FIELD

The present invention relates to a device for preventing the loosening of components of a turnbuckle.

### BACKGROUND

A turnbuckle is a commonly used device which has the purpose of tightening a line or wire. There are two common types: a closed-body turnbuckle and an open-bodies turnbuckle. This invention relates to the open-bodied turnbuckle where the threaded line terminal, for example, the screw stud, has an accessible hole in the distal end.

Traditionally there have been two methods of preventing the open-bodied turnbuckle from unwinding: a cotter pin (more permanent), and a cotter ring (when frequent adjusting to tension is needed, as in the case of the shrouds of small racing sailboats, where changing tension to match the speed of the wind is desirable). There is also a more recent modification of the cotter pin which involves at pin attached to a Velcro® strap. The present disclosure discusses an advancement in an anti-rotation locking mechanism for a turnbuckle.

### SUMMARY OF INVENTION

A device for locking a turnbuckle is provided. The device comprises a clip which attaches to the barrel of the turnbuckle, said clip having a pin affixed to the inner circle which is configured to insert into the hole in the stud to prevent rotation. Systems and methods are disclosed.

In some embodiments, said clip is made from spring steel.

In some embodiments, a tongue is attached to the clip which fits into the turnbuckle providing additional protection from loosening of the turnbuckle and also acting as a guide for inserting the clip.

### DESCRIPTION OF THE DRAWINGS

The present disclosure will become more readily apparent from the specific description accompanied by the following drawings, in which:

FIG. 1 is a perspective view of the components of one embodiment in accordance with the principles of the present disclosure;

FIG. 2 is a perspective view of the components of one embodiment in accordance with the principles of the present disclosure;

FIG. 3 is a perspective view of the components of one embodiment in accordance with the principles of the present disclosure;

FIG. 4 is a perspective view of the components of one embodiment in accordance with the principles of the present disclosure;

FIG. 5 is a top view of the components of one embodiment in accordance with the principles of the present disclosure;

FIG. 6 is a top view of the components of one embodiment in accordance with the principles of the present disclosure;

FIG. 7 is a top view of the components of one embodiment in accordance with the principles of the present disclosure;

FIG. 8 is a perspective view of the components of one embodiment in accordance with the principles of the present disclosure;

FIG. 9 is a perspective view of the components of one embodiment in accordance with the principles of the present disclosure;

FIG. 10 is a perspective view of the components of one embodiment of the turnbuckle locking device in accordance with the principles of the present disclosure;

FIG. 11 is a perspective view of the components of one embodiment of the turnbuckle locking device in accordance with the principles of the present disclosure;

FIG. 12 is a perspective view of the components of one embodiment of the turnbuckle locking device in accordance with the principles of the present disclosure;

FIG. 13 is a top view of the components of one embodiment of the turnbuckle locking device in accordance with the principles of the present disclosure;

FIG. 14 is a top view of the components of one embodiment of the turnbuckle locking device in accordance with the principles of the present disclosure;

FIG. 15 is a top view of the components of one embodiment of the turnbuckle locking device in accordance with the principles of the present disclosure;

FIG. 16 is a perspective view of the components of one embodiment of the turnbuckle locking device in accordance with the principles of the present disclosure;

FIG. 17 is a perspective view of the components of one embodiment of the turnbuckle locking device in accordance with the principles of the present disclosure;

FIG. 18 is a top view, with part cross section, of the components of one embodiment of the turnbuckle locking device in accordance with the principles of the present disclosure;

FIG. 19 is a top view, with part cross section, of the components of one embodiment of the turnbuckle locking device in accordance with the principles of the present disclosure;

FIG. 20 is a top view, with part cross section, of the components of one embodiment of the turnbuckle locking device in accordance with the principles of the present disclosure;

FIG. 21 is a top view, with part cross section, of the components of one embodiment of the turnbuckle locking device in accordance with the principles of the present disclosure;

FIG. 22 is a perspective view, with part cross section, of the components of one embodiment of the turnbuckle locking device in accordance with the principles of the present disclosure; and

FIG. 23 is a perspective view, with part cross section, of the components of one embodiment of the turnbuckle locking device in accordance with the principles of the present disclosure.

### DETAILED DESCRIPTION

The described features, structures, or characteristics of the invention may be combined in any suitable manner in one or more embodiments. In the following description, numerous specific details are included to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

A turnbuckle, stretching screw or bottle screw is a device for adjusting the tension or length of ropes, cables, tie rods, and other tensioning systems. It normally consists of two threaded eye bolts, for example, screw studs. One screwed into each end of a small metal frame, one with a left-hand thread and the other with a right-hand thread. The tension can be adjusted by rotating the frame, which causes both screw studs to be screwed in or out simultaneously, without twisting the screw studs or attached cables. Turnbuckles are most commonly used in applications which require a great deal of tension; they can range in mass from about ten grams for thin cable used in a garden fence, to thousands of kilograms for structural elements in buildings and suspension bridges. A turnbuckle can adjust the tension or length of ropes, cables, tie rods, and other tensioning systems, for example, shrouds on a sailboat. Shrouds are pieces of standing rigging which hold the mast up from side to side. There is frequently more than one shroud on each side of the boat. Turnbuckles are utilized to allow for adjustment of tension and/or fixation of the shrouds. There are various types of turnbuckles, for example, eye turnbuckles, hook turnbuckles and stub end turnbuckles.

In some embodiments, the present disclosure includes a clip configured to resist and/or prevent rotation of the screw stud of the turnbuckle. In some embodiments, the clip includes a pin for inserting into a hole in the screw stud to resist and/or prevent rotation of the screw stud. In some embodiments, the clip includes a tab which both guides the clip into the turnbuckle and prevents the pin from turning. The clip is sized for the turnbuckle, ranging from a small turnbuckle to a large turnbuckle. The system of the present disclosure may be understood more readily by reference to the following detailed description of the embodiments taken in connection with the accompanying drawing figures, which form a part of this disclosure.

In some embodiments, the advantages the clip over currently used devices are that the clip is configured for a toolless engagement with the turnbuckle. The clip is configured to be reusable as it can be removed easily. The clip is configured to eliminate a small movement of a toggle. The clip is durable and provides less snagging.

It is to be understood that this application is not limited to the specific devices, methods, conditions or parameters described and/or shown herein, and that the terminology used herein is for the purpose of describing particular embodiments by way of example only and is not intended to be limiting. In some embodiments, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

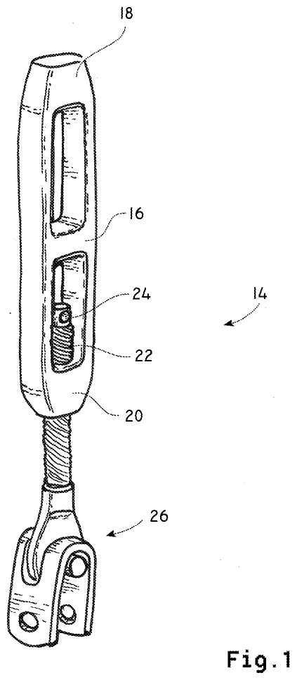

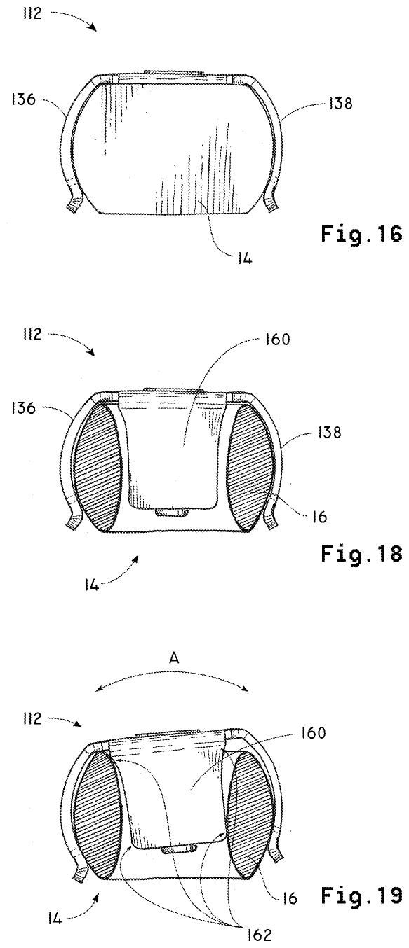

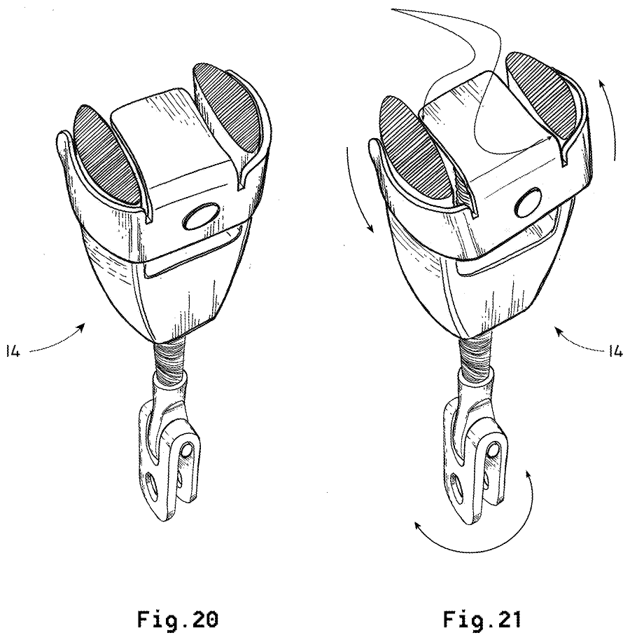

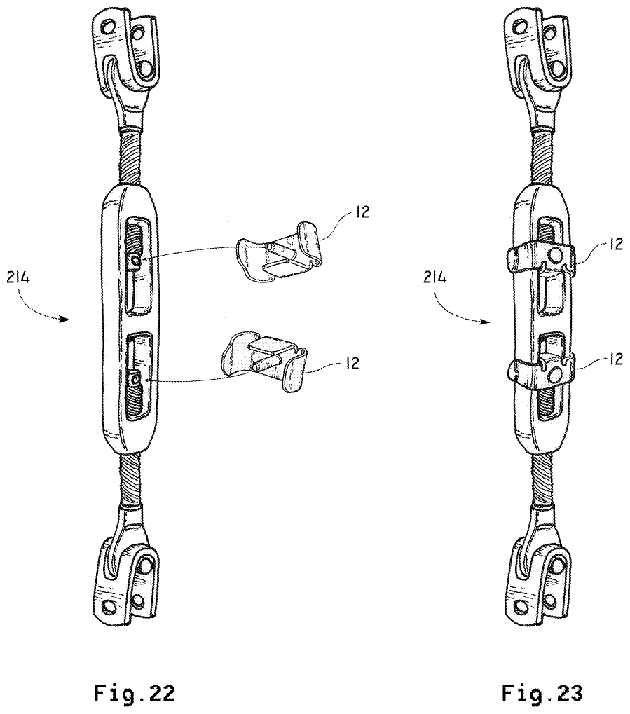

The following discussion includes a description of a clip that prevents turning of a turnbuckle in accordance with the principles of the present disclosure. Reference is made in detail to the exemplary embodiments of the present disclosure, which are illustrated in the accompanying figures. Turning to FIGS. 1-23, there are illustrated components of a securing system 10 including a clip 12 configured for engagement with a turnbuckle 14.

Turnbuckle 14, as shown in FIG. 1, is an open turnbuckle and a coupling device specially designed to alter the applied tension slowly without spinning the cable/rope to which it is attached. This kind of fastener is enabled with an elongated body 16 extending between and end 18 and an end 20. Turnbuckle 14 internal screw studs 22, so that they can be pulled together or pushed farther apart by twisting the central nut. One end of screw studs 22 includes a through hole 24, as shown in FIG. 1. At an opposite end of screw studs 22 a hook or screw-eye 26 is provided. When screw studs 22 are threaded into turnbuckle 14 and turnbuckle 14 is rotated, screw studs 22 eject out of body 16, thereby releasing tension. And when it is turned in a counter-clockwise direction, screw studs 22 are driven towards the center, thereby increasing tension.

Turnbuckles 14 are most commonly used in applications which require a great deal of tension; they can range in mass from about ten grams for thin cable used in a garden fence, to thousands of kilograms for structural elements in buildings and suspension bridges.

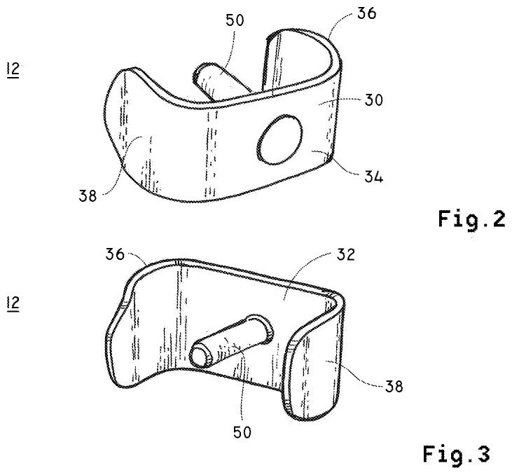

To fix turnbuckle 12 to resist and/or prevent rotation of screw threads 22, a locking device, for example, clip 12 as shown in FIGS. 2 and 3 is provided. Clip 12 includes a plate 30 having a surface 32 and a surface 34. Clip 12 includes an arm 36 and an arm 38. Arms 36, 38 extend from surface 32. Each arm 36, 38 includes a ramped portion 40 configured to facilitate engagement with turnbuckle 14, as described herein. In some embodiments, clip 12 includes stainless steel.

Arms 36, 38 are resiliently biased between a first, contracted orientation and a second, expanded orientation such that arms 36, 38 are configured for a snap fit engagement with body 16 of turnbuckle 14. In some embodiments, arms 36, 38 may be connected with body 16 via integral connection, pressure fit, interlocking engagement, mating engagement, dovetail connection, clips, barbs, tongue in groove, threaded, magnetic and/or key/keyslot.

An extension, for example, a pin 50 extends from surface 32. Pin 50 is configured for insertion into hole 24. Pin 50 engages screw studs 22 to resist and/or prevent rotation of screw studs 22 relative to body 16.

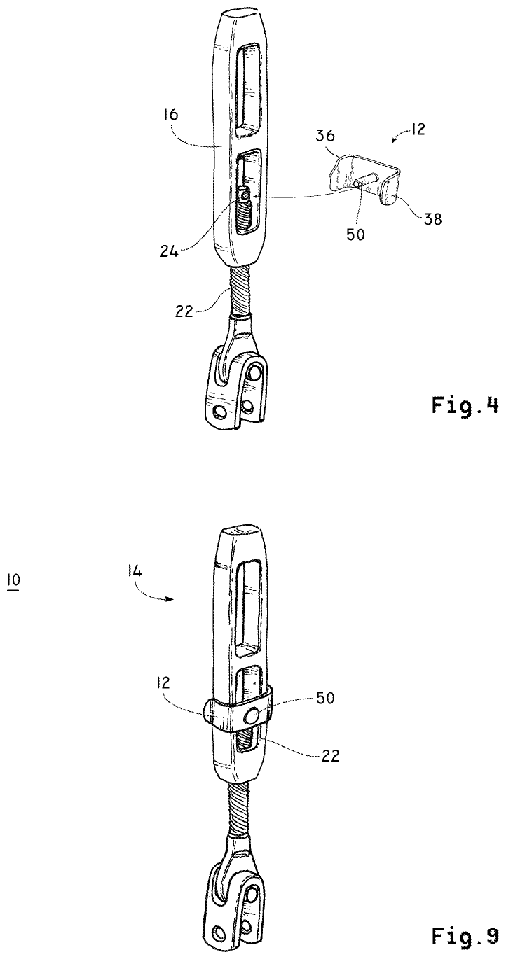

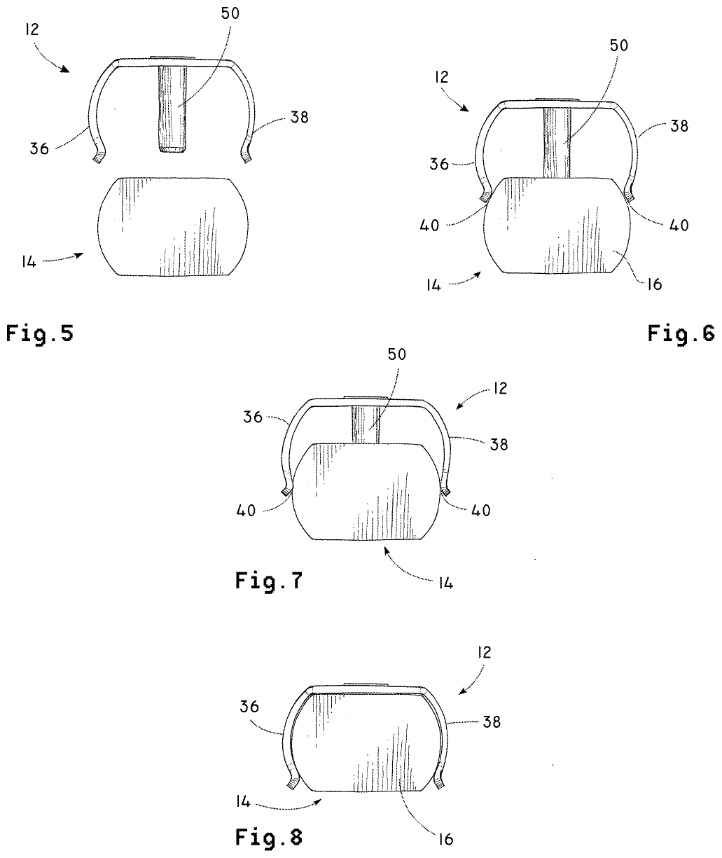

In use, turnbuckle 14 is manipulated to adjust a tension of ropes and or wires accordingly. Clip 12 is disposed adjacent body 16 to align pin 50 with through hole 24, as shown in FIGS. 4 and 5. Arms 36, 38 are oriented in the contracted orientation and positioned adjacent body 16, as shown in FIG. 6. Clip 12 is engaged with body 16, for example, by pressing clip 12 against body 16. The force applied to clip 12 causes ramped portion 40 to translate along the surface of body 16 causing arms 36, 38 to splay into the expanded ordination, as shown in FIG. 7. As clip 12 translates over body 16, arms 36, 38 resiliently bias back into the contracted orientation forming a snap fit with body 16 to hold pin 50 in place such that pin 50 resists and/or prevents screw stud 22 from rotating.

Clip 12 is configured for a toolless engagement with turnbuckle 14. Clip 12 is configured to be reusable as it can be removed easily. Clip 12 is configured to eliminate a small movement of a toggle. Clip 12 is durable and provides less snagging.

In some embodiments, system 110, similar to system 10, includes turnbuckle 14, as described herein, and a clip 112. Clip 112 includes a plate 130 having a surface 132 and a surface 134. Clip 112 includes an arm 136 and an arm 138. Arms 136, 138 extend from surface 132. Each arm 136, 138 includes a ramped portion 140 configured to facilitate engagement with turnbuckle 14, as described herein. In some embodiments, clip 112 includes stainless steel.

Arms 136, 138 are resiliently biased between a first, contracted orientation and a second, expanded orientation such that arms 136, 138 are configured for a snap fit engagement with body 16 of turnbuckle 14. A pin 150 extends from surface 132. Pin 150 is configured for insertion into hole 124. Pin 150 engages screw studs 22 to resist and/or prevent rotation of screw studs 22 relative to body 16.

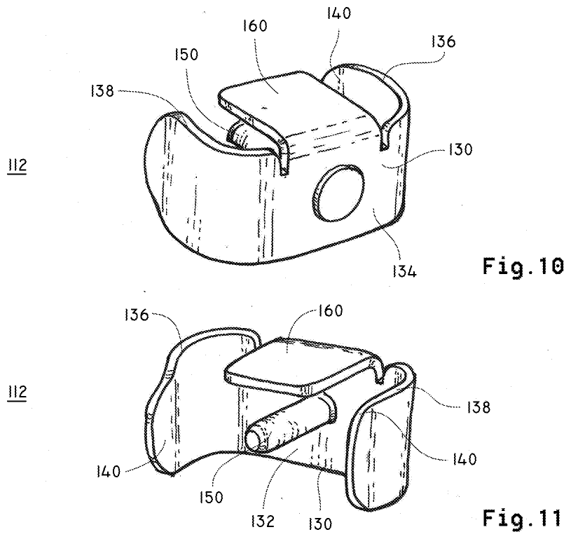

Clip 112 includes a tab 160 extending from surface 132, as shown in FIGS. 10 and 11. Tab 160 is configured for disposal with an opening in body 16 adjacent screw stud 22. Tab 160 provides an extra mechanism to resist and/or prevent rotation of screw stud 22. Tab 160 includes surfaces 162 configured to contact an inner surface of body 16 to resist rotation, as shown in FIGS. 18-21. For example, as turnbuckle 14 rotates under tension, as shown by arrows A in FIG. 19, surfaces 162 engages the inner surfaces of body 16 to prevent rotation of clip 112 out of engagement with turnbuckle 14.

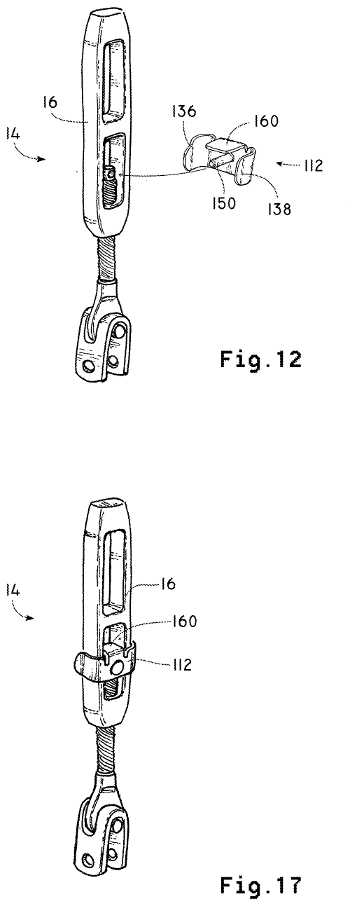

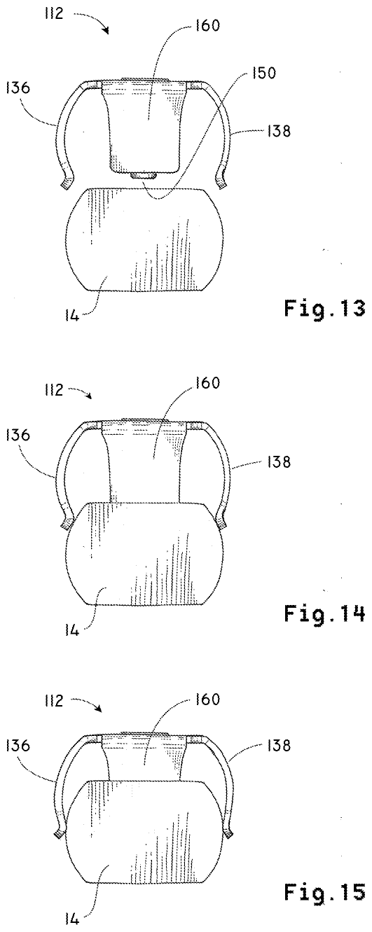

In use, turnbuckle 14 is manipulated to adjust a tension of ropes and or wires accordingly. Clip 112 is disposed adjacent body 16 to align pin 150 with through hole 24 and align tab 160 with an opening in body 16, as shown in FIGS. 12 and 13. Arms 136, 138 are oriented in the contracted orientation and positioned adjacent body 16, as shown in FIG. 14. Clip 112 is engaged with body 16, for example, by pressing clip 112 against body 16. The force applied to clip 112 causes ramped portions 140 to translate along the surface of body 16 causing arms 136, 138 to splay into the expanded ordination, as shown in FIG. 15. As clip 112 translates over body 16, arms 136, 138 resiliently bias back into the contracted orientation forming a snap fit with body 16 to hold pin 150 and tab 160 in place to resist and/or prevent screw stud 22 from rotating.

In some embodiments, system 210, similar to system 10, includes a double ended turnbuckle 214, as show in FIGS. 22 and 23. Turnbuckle 214 is configured for use with clip 12 and/or clip 112, as described herein.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A device for fixing a turnbuckle comprising:
a clip having an inner surface;
a pair of arms extending from the inner surface, the arms are configured to capture a portion of the turnbuckle;
a pin extending from the inner surface, wherein the pin is configured for disposal with a portion of the turnbuckle to resist rotation.

2. A device for fixing a turnbuckle according to claim 1, wherein the arms are flexible.

3. A device for fixing a turnbuckle according to claim 1, wherein the arms are moveable between a first, contracted orientation and a second, expanded orientation.

4. A device for fixing a turnbuckle according to claim 1, wherein the arms are configured to snap fit with the turnbuckle.

5. A device for fixing a turnbuckle according to claim 1, wherein the arms each include a ramped surface to facilitate engagement with the turnbuckle.

6. A device for fixing a turnbuckle according to claim 1, wherein the clip includes a tab extending from the inner surface.

7. A turnbuckle fixation system comprising:
an open turnbuckle having a body and at least one screw stud having a through hole; and
a clip having an inner surface; a pair of arms extending from the inner surface, the arms are configured to capture the body of the turnbuckle; a pin extending from the inner surface, wherein the pin is configured for disposal with the through hole of the screw stud to resist rotation.

8. A device for fixing a turnbuckle according to claim 7, wherein the arms are flexible.

9. A device for fixing a turnbuckle according to claim 7, wherein the arms are moveable between a first, contracted orientation and a second, expanded orientation.

10. A device for fixing a turnbuckle according to claim 7, wherein the arms are configured to snap fit with the turnbuckle.

11. A device for fixing a turnbuckle according to claim 7, wherein the arms each include a ramped surface to facilitate engagement with the turnbuckle.

12. A device for fixing a turnbuckle according to claim 7, wherein the clip includes a tab extending from the inner surface.
